(19) United States
(12) Patent Application Publication
(10) Pub. No.: US 2010/0175844 A1
(43) Pub. Date: Jul. 15, 2010

(54) USE OF MILL DRIED ALUMINUM HYDROXIDE PARTICLES IN PAPER MANUFACTURING AND PAPER PRODUCT COATINGS

(75) Inventor: Thomas Maus, Julich (DE)

Correspondence Address: ALBEMARLE CORPORATION;PATENT DEPARTMENT, 451 FLORIDA STREET, BATON ROUGE, LA, 70801, US

(73) Assignee: MARTINSWERK GMBH, Bergheim (DE)

(21) Appl. No.: 12/597,998

(22) PCT Filed: Jun. 4, 2008
(86) PCT No.: PCT/EP2008/004439

§ 371 Date: Mar. 22, 2010

Related U.S. Application Data
(60) Provisional application No. 60/941,759, filed on Jun. 4, 2007.
(60) Provisional application No. 60/941,762, filed on Jun. 4, 2007.

(51) Int. Cl. D21H 19/36; D21H 17/63; D21H 13/00; C09D 1/00

(52) U.S. Cl. 162/157.1; 162/181.5; 106/287.17

(57) ABSTRACT

The present invention relates to the use of mill-dried aluminum hydroxide particles (i) as fillers, such as opacity and/or brightness and/or printability improvers, in the production of paper and (ii) in coatings suitable for use on paper and paper products and the paper and paper products having the coating applied thereto.

### FIELD OF THE INVENTION

The present invention relates to the use of aluminum hydroxide particles in the production of paper and in paper product coatings. More particularly, the present invention relates to the use of mill-dried aluminum hydroxide particles as fillers, such as opacity and/or brightness and/or printability improvers, in the production of paper. Also, the present invention relates to the use of mill dried aluminium hydroxide particles in coatings suitable for use on paper and paper products and the paper and paper products having the coating applied thereto.

### BACKGROUND OF THE INVENTION

Aluminum hydroxide has a variety of alternative names such as aluminum hydrate, aluminum trihydrate etc., but is commonly referred to as ATH. ATH particles find use as a filler in many materials such as, for example, plastics, rubber, thermosets, papers, etc.

### THE INVENTION

The ATH particles that are used in the practice of the present invention can be readily produced by the process described herein, i.e. mill drying a slurry or filter cake as described below. The inventor hereof has discovered that the ATH particles used in the practice of the present invention are more readily dispersible in water and coating formulations, thus allowing for superior coating formulations and also better coated paper, when compared to currently available coating formulations using conventional ATH particles and the coated paper made therefrom.

### BRIEF DESCRIPTION OF THE FIGURES

The invention will be better understood by reference to the Figures in which:

FIG. 1 is a graph depicting the shear stress versus the shear rate for an ATH product slurry called MARTIGLOSS, a commercially available ATH product.

FIG. 2 is a graph depicting the shear stress versus the shear rate for an NTH product slurry called MARTIFIN OL-008U, a trial ATH product.

FIG. 3 is a graph depicting the shear stress versus the shear rate for an ATH product slurry made from a mill-dried ATH product according to the present invention.

### FILTER CAKE

In one embodiment of the present invention a filter moist cake, sometimes referred to herein as simply a filter cake, containing ATH particles is mill-dried to produce the mill-dried ATH particles used in the practice of the present invention. The filter cake typically contains in the range of from about 25 to about 85 wt. % ATH particles, based on the total weight of the filter cake. The filter cake can contain in the range of from about 40 to about 70 wt. % ATH particles, or in the range of from about 50 to about 60 wt. % ATH particles, both on the same basis.

In other embodiments, the filter cake contains in the range of from about 40 to about 60 wt. % ATH particles, or in the range of from about 45 to about 55 wt. % ATH particles, both on the same basis. In still other embodiments, the filter cake contains in the range of from about 25 to about 50 wt. % ATH particles, or in the range of from about 30 to about 45 wt. % ATH particles, both on the same basis

The filter cake used in the practice of the present invention can be obtained from any process used to produce ATH particles. The filter cake can be obtained from a process that involves producing ATH particles through precipitation and filtration. In an exemplary embodiment, the filter cake is obtained from a process that comprises dissolving crude aluminum hydroxide in caustic soda to form a sodium aluminate liquor, which is cooled and filtered thus forming a sodium aluminate liquor useful in this exemplary embodiment. The sodium aluminate liquor thus produced typically has a molar ratio of Na₂O to Al₂O₃ in the range of from about 1.4:1 to about 1.55:1. In order to precipitate ATH particles from the sodium aluminate liquor, ATH seed particles are added to the sodium aluminate liquor in an amount in the range of from about 1 g of ATH seed particles per liter of sodium aluminate liquor to about 3 g of ATH seed particles per liter of sodium aluminate liquor thus forming a process mixture. The ATH seed particles are added to the sodium aluminate liquor when the sodium aluminate liquor is at a liquor temperature of from about 45 to about 80° C. After the addition of the ATH seed particles, the process mixture is stirred for about 100 h or alternatively until the molar ratio of Na₂O to Al₂O₃ is in the range of from about 2.2:1 to about 3.5:1, thus forming an ATH suspension. The obtained ATH suspension typically comprises from about 80 to about 160 g/l ATH, based on the suspension. However, the ATH concentration can be varied to fall within the ranges described above. The obtained ATH suspension is then filtered and washed to remove impurities therefrom, thus forming a filter cake. Before the filter cake is mill-dried, it can be washed one time, or in some embodiments more than one time, with water, for example, de-salted water.

Before mill drying, the filter cake can be re-slurried with water to form a slurry, or in some embodiments, at least one, or only one, dispersing agent is added to the filter cake to form a slurry, as described below. It should be noted that it is also possible to re-slurry the filter cake with a combination of water and a dispersing agent. Non-limiting examples of dispersing agents include polyacrylates, polyacrylic acids, organic acids, naphtalensulfonate/formaldehyde condensate, fatty-alcohol-polyglycol-ether, polypropylene-ethylenoxid, polyglycol-ester, polyamine-ethylenoxid, phosphate, polyvinylalcohole. In this embodiment, the remainder of the slurry (i.e. not including the ATH particles and the dispersing agent(s)) is typically water, although some reagents, contaminants, etc. may be present from precipitation.

### Slurry

If the filter cake is re-slurried with water only, the slurry generally contains in the range of from about 1 to about 40 wt. % ATH, based on the total weight of the slurry, or in the range of from about 5 to about 40 wt. % ATH, or in the range of from about 10 to about 35 wt. % ATH, or in the range of from about 20 to about 30 wt. % ATH, all on the same basis.

If a dispersing agent alone or in combination with additional water is used to re-slurry the filter cake, the slurry may contain up to about 80 wt. % ATH, based on the total weight of the slurry, because of the effects of the dispersing agent. Thus, in this embodiment, the slurry typically comprises in the range of from 1 to about 80 wt. % ATH, based on the total weight of the slurry, or the slurry comprises in the range of from about 40 to about 75 wt. %, or in the range of from about 45 to about 70 wt. %, or in the range of from about 50 to about 65 wt. %, ATH, based on the total weight of the slurry.

### ATH Particles in the Slurry and Filter Cake

The ATH particles in the slurry or filter cake can be generally characterized as having a BET in the range of from about 1.0 to about 4.0 m²/g. The ATH particles in the slurry or filter cake can have a BET in the range of from about 1.5 to about 2.5 m²/g. In these embodiments, the ATH particles in the slurry or filter cake can also be further characterized as having a d₅₀ in the range of from about 1.8 to about 3.0 μm, which is coarser than the mill-dried ATH particles used in the coatings of the present invention.

In other embodiments, the ATH particles in the slurry or filter cake are characterized as having a BET in the range of from about 4.0 to about 8.0 m²/g. The ATH particles in the slurry or filter cake can have a BET in the range of from about 5 to about 7 m²/g. In these embodiments, the ATH particles in the slurry or filter cake can also be further characterized as having a d₅₀ in the range of from about 1.0 to about 2.0 μm, which is coarser than the mill-dried ATH particles used in the coatings or coating formulations of the present invention.

In still other embodiments, the ATH particles in the slurry or filter cake are characterized as having a BET in the range of from about 8.0 to about 14 m²/g. The ATH particles in the slurry can have a BET in the range of from about 9 to about 12 m²/g. In these embodiments, the ATH particles in the slurry or filter cake can also be further characterized as having a d₅₀ in the range of from about 0.9 to about 1.8 μm, which is coarser than the mill-dried ATH particles used in the present invention.

By coarser than the mill-dried ATH particles used in the present invention, it is meant that the upper limit of the d₅₀ value of the ATH particles in the slurry or filter cake is generally at least about 0.2 μm higher than the upper limit of the d₅₀ of the mill-dried ATH particles used in the present invention.

The inventor hereof, while not wishing to be bound by theory, believe that in some embodiments, the improved dispersability and morphology of the ATH particles produced as described herein and used in the present invention is at least partially attributable to the process used to precipitate the ATH. Thus, while mill-drying techniques are known in the art, the inventor hereof have discovered that by using the precipitation and filtration processes described herein, in some embodiments, along with the mill-drying process described herein, ATH particles having improved dispersability and morphology, as described below, can be readily produced.

### Mill-Drying

The ATH particles used in the present invention can be produced by mill drying a slurry or filter cake, as described above. “Mill-drying” and “mill-dried” as used herein, it is meant that slurry or filter cake is dried in a turbulent hot air-stream in a mill drying unit. The mill drying unit comprises a rotor that is firmly mounted on a solid shaft that rotates at a high circumferential speed. The rotational movement in connection with a high air through-put converts the through-flowing hot air into extremely fast air vortices which take up the mixture to be dried, accelerate it, and distribute and dry the slurry or filter cake. After having been dried completely, the mill-dried ATH particles are transported via the turbulent air out of the mill and separated from the hot air and vapors by using conventional filter systems. In another embodiment of the present invention, after having been dried completely, the mill-dried ATH particles are transported via the turbulent air through an air classifier which is integrated into the mill, and are then transported via the turbulent air out of the mill and separated from the hot air and vapors by using conventional filter systems.

The throughput of the hot air used to dry the slurry or filter cake is typically greater than about 3,000 Bm³/h, or greater than about 5,000 Bm³/h, or from about 3,000 Bm³/h to about 40,000 Bm³/h, or from about 5,000 Bm³/h to about 30,000 Bm³/h.

In order to achieve throughputs this high, the rotor of the mill drying unit typically has a circumferential speed of greater than about 40 m/sec, or greater than about 60 m/sec, or greater than 70 m/sec, or in a range of about 70 m/sec to about 140 m/sec. The high rotational speed of the motor and high throughput of hot air results in the hot air stream having a Reynolds number greater than about 3,000.

The temperature of the hot air stream used to mill dry the slurry or filter cake is generally greater than about 150° C., or greater than about 270° C. The temperature of the hot air stream can be in the range of from about 150° C. to about 550° C., or in the range of from about 270° C. to about 500° C.

The mill-drying of the slurry or filter cake produces mill-dried ATH particles that have a larger BET specific surface area, as determined by DIN-66132, then the starting ATH particles in the slurry or filter cake. Typically, the BET of the mill-dried ATH are more than about 10% greater than the ATH particles in the slurry or filter cake. The BET of the mill-dried ATH can be in the range of from about 10% to about 40% greater than the ATH particles in the slurry or filter cake. The BET of the mill-dried ATH particles can be in the range of from about 10% to about 25% greater than the ATH particles in the slurry or filter cake.

### Mill-Dried ATH Particles

In general, the mill-dried ATH particles used in the practice of the present invention can be characterized by many different properties. Generally, the mill-dried ATH particles have an oil absorption, as determined by ISO 787-5:1980 of in the range of from about 1 to about 35%, a BET specific surface area, as determined by DIN-66132, in the range of from about 1 to 15 m²/g, a d₅₀ in the range of from about 0.5 to 2.5 μm.

The mill-dried ATH particles used in the practice of the present invention can also be described as having a median pore radius (“r₅₀”) and specific pore volume at about 1000 bar (“Vₘₐₓ”). The r₅₀ and Vₘₐₓ of the mill-dried ATH particles used in the practice of the present invention can be derived from mercury porosimetry. The theory of mercury porosimetry is based on the physical principle that a non-reactive, non-wetting liquid will not penetrate pores until sufficient pressure is applied to force its entrance. Thus, the higher the pressure necessary for the liquid to enter the pores, the smaller the pore size. The pore size of the mill-dried ATH particles used in the present invention can be calculated from data derived from mercury porosimetry using a Porosimeter 2000 from Carlo Erba Strumentazione, Italy. According to the manual of the Porosimeter 2000, the following equation is used to calculate the pore radius r from the measured pressure p: r=−2γ cos(θ)/p; wherein θ is the wetting angle and γ is the surface tension. The measurements taken herein used a value of 141.3° for θ and γ was set to 480 dyn/cm.

In order to improve the repeatability of the measurements, the pore size of the mill-dried ATH particles used herein was calculated from the second ATH intrusion test run, as described in the manual of the Porosimeter 2000. The second test run was used because the inventor observed that an amount of mercury having the volume V₀ remains in the sample of the ATH particles after extrusion, i.e. after release of the pressure to ambient pressure. Thus, the r₅₀ can be derived from this data as explained below.

In the first test run, a sample of mill-dried ATH particles was prepared as described in the manual of the Porosimeter 2000, and the pore volume was measured as a function of the applied intrusion pressure p using a maximum pressure of 1000 bar. The pressure was released and allowed to reach ambient pressure upon completion of the first test run. A second intrusion test nm (according to the manual of the Porosimeter 2000) utilizing the same ATH sample, unadulterated, from the first test run was performed, where the measurement of the specific pore volume V(p) of the second test run takes the volume V₀ as a new starting volume, which is then set to zero for the second test run.

In the second intrusion test run, the measurement of the specific pore volume V(p) of the sample was again performed as a function of the applied intrusion pressure using a maximum pressure of 1000 bar. The pore volume at about 1000 bar, i.e. the maximum pressure used in the measurement, is referred to as Vₘₐₓ herein.

From the second ATH intrusion test run, the pore radius r was calculated by the Porosimeter 2000 according to the formula r=−2γ cos(θ)/p; wherein θ is the wetting angle, γ is the surface tension and p the intrusion pressure. For all r-measurements taken herein, a value of 141.3° for θ was used and γ was set to 480 dyn/cm. If desired, the specific pore volume can be plotted against the pore radius r for a graphical depiction of the results generated. The pore radius at 50% of the relative specific pore volume, by definition, is called median pore radius r₅₀ herein.

For a graphical representation of r₅₀ and Vₘₐₓ, please see PCT Application Nos. IB07/004405 (publication no. 2008/075203), IB07/003007 (publication no. 2008/001226), IB07/003970 (publication no. 2008/047237), IB07/004509 (publication no. 2008/090415), and U.S. Ser. No. 07/071,817, which are all incorporated herein in their entirety by reference.

The procedure described above was repeated using samples of mill-dried ATH particles suitable for use herein, and the mill-dried ATH particles used in the present invention were found to have an r₅₀, i.e. a pore radius at 50% of the relative specific pore volume, in the range of from about 0.09 to about 0.33 μm. The r₅₀ of the mill-dried ATH particles used in the present invention can be in the range of from about 0.20 to about 0.33 μm, or in the range of from about 0.2 to about 0.3 μm. The r₅₀ can be in the range of from about 0.185 to about 0.325 μm, or in the range of from about 0.185 to about 0.25 μm. The r₅₀ can be in the range of from about 0.09 to about 0.21 μm, or in the range of from about 0.09 to about 0.165 μm.

The mill-dried ATH particles used in the present invention can also be characterized as having a Vₘₐₓ, i.e. maximum specific pore volume at about 1000 bar, in the range of from about 300 to about 700 mm³/g. The Vₘₐₓ of the mill-dried ATH particles used in the present invention can be in the range of from about 390 to about 480 mm³/g, or in the range of from about 410 to about 450 mm³/g. The Vₘₐₓ can be in the range of from about 400 to about 600 mm³/g, or in the range of from about 450 to about 550 mm³/g. The Vₘₐₓ can be in the range of from about 300 to about 700 mm³/g, or in the range of from about 350 to about 550 mm³/g.

The mill-dried ATH particles used in the present invention can also be characterized as having an oil absorption, as determined by ISO 787-5:1980 of in the range of from about 1 to about 35%. The mill-dried ATH particles used in the present invention can be characterized as having an oil absorption in the range of from about 23 to about 30%, or in the range of from about 25% to about 28%. The mill-dried ATH particles used in the present invention can be characterized as having an oil absorption in the range of from about 25% to about 32%, or in the range of from about 26% to about 30%. The mill-dried ATH particles used in the present invention can be characterized as having an oil absorption in the range of from about 25% to about 35%, or in the range of from about 27% to about 32%. In other embodiments, the oil absorption of the mill-dried ATH particles used in the present invention are in the range of from about 19% to about 23%, and in still other embodiments, the oil absorption of the mill-dried ATH particles produced by the present invention is in the range of from about 21% to about 25%.

The mill-dried ATH particles used in the present invention can also be characterized as having a BET specific surface area, as determined by DIN-66132, in the range of from about 1 to 15 m²/g. The mill-dried ATH particles used in the present invention have a BET specific surface in the range of from about 3 to about 6 m²/g, or in the range of from about 3.5 to about 5.5 m²/g. The mill-dried ATH particles used in the present invention can have a BET specific surface of in the range of from about 6 to about 9 m²/g, or in the range of from about 6.5 to about 8.5 m²/g. The mill-dried ATH particles used in the present invention can have a BET specific surface in the range of from about 9 to about 15 m²/g, or in the range of from about 10.5 to about 12.5 m²/g.

The mill-dried ATH particles used in the present invention can also be characterized as having a d₅₀ in the range of from about 0.5 to 2.5 μm. The mill-dried ATH particles used in the present invention can have a d₅₀ in the range of from about 1.5 to about 2.5 μm or in the range of from about 1.8 to about 2.2 μm. The mill-dried ATH particles used in the present invention can have a d₅₀ in the range of from about 1.3 to about 2.0 μm, or in the range of from about 1.4 to about 1.8 μm. The mill-dried ATH particles used in the present invention can have a d₅₀ in the range of from about 0.9 to about 1.8 μm, or in the range of from about 1.1 to about 1.5 μm.

It should be noted that all particle diameter measurements, i.e. d₅₀, disclosed herein were measured by laser diffraction using a Cilas 1064 L laser spectrometer from Quantachrome. Generally, the procedure used herein to measure the d₅₀, can be practiced by first introducing a suitable water-dispersant solution (preparation see below) into the sample-preparation vessel of the apparatus. The standard measurement called “Particle Expert” is then selected, the measurement model “Range 1” is also selected, and apparatus-internal parameters, which apply to the expected particle size distribution, are then chosen. It should be noted that during the measurements the sample is typically exposed to ultrasound for about 60 seconds during the dispersion and during the measurement. After a background measurement has taken place, from about 75 to about 100 mg of the sample to be analyzed is placed in the sample vessel with the water/dispersant solution and the measurement started. The water/dispersant solution can be prepared by first preparing a concentrate from 500 g Calgon, available from KMF Laborchemie, with 3 liters of CAL Polysalt, available from BASF. This solution is made up to 10 liters with deionized water. 100 ml of this original 10 liters is taken and in turn diluted further to 10 liters with deionized water, and this final solution is used as the water-dispersant solution described above.

### Mill-Dried ATH Product Slurries

The mill-dried ATH particles can be made into mill-dried ATH product slurries to be sent to paper manufacturers for their use as filler in paper production and for use in coatings and coating formulations. The mill-dried ATH product slurries can be produced by adding a dispersing agent, in some embodiments a dispersing agent and water, to mill-dried ATH particles. Suitable dispersing agents are those described above.

Because of the dispersability of the mill-dried ATH particles, product slurries can be produced that have a higher solids content than presently available. With currently available ATH particles, product slurries of up to about 65 to about 66 wt. % ATH particles, based on the total weight of the product slurry, can be produced if the right dispersing agent is used. However, product slurries with ATH particle contents higher than this are typically not possible without the product slurry suffering rheological problems like dilatancy. However, the present mill-dried ATH particles can be used to produce mill-dried ATH product slurries having a mill-dried ATH particle content of up to about 85 wt. % mill-dried ATH particles, based on the total weight of the mill-dried ATH product slurry. In some embodiments, the mill-dried ATH product slurry contains in the range of from about 65 to about 75 wt. % mill-dried ATH particles, sometimes in the range of from about 68 to about 75 wt. % mill-dried ATH particles, in some embodiments in the range of from about 70 to about 74 wt. % mill-dried ATH particles, all on the same basis. The higher ATH content of the mill-dried ATH product slurries of the present invention also provide the added benefit that the end user can work with slurries, and create coatings, having higher solid contents and better rheological properties than previously available, as described below.

In some embodiments, the solids content of ATH slurries produced with the mill-dried ATH particles described herein can be in the range of from about 50 wt. % to about 85 wt. %, in some embodiments in the range of from about 60 wt. % to about 80 wt. %, in some embodiments in the range of from about 65 wt. % to about 75 wt. %.

The mill-dried ATH product slurries can have a viscosity, as determined by representative dynamical viscosity at 25° C. and a shear rate of 1007/second, in the range of from about 10 mPa*s ((millipascals) (seconds)) to about 60 mPa*s, or in the range from 25 mPa*s to 45 mPa*s. For measuring viscosity, several machines can be used, for example, a Contraves Rheometer at a shear rate of 1007/second.

### Use of Mill-Dried ATH in Paper Production

The mill-dried ATH particles of the present invention are suitable for use as a filler in the production of paper. For example, the mill-dried ATH particles can be used as opacity and/or brightness and/or printability and/or flame retardant improvers in the production of paper. Generally the amount of mill-dried ATH particles used is in the range of from about 2 wt. % to about 60 wt. %, based on dry paper weight. If the mill dried ATH particles are used as opacity/brightness/printability improvers, they are generally used in an amount in the range of from about 2 wt. % to about 30 wt. %, or in the range of from about 3 wt. % to about 20 wt. %, or in the range of from about 5 wt. % to about 15 wt. %, all based on dry paper weight. If the mill dried ATH particles are used as flame retardant improvers, they are generally used in an amount in the range of from about 5 wt. % to about 60 wt. %, or in the range of from about 10 wt. % to about 55 wt. %, or in the range of from about 25 wt. % to about 45 wt. %, all based on dry paper weight.

The mill-dried ATH particles are compatible with essentially any pulp known, and are typically added to the pulp in the wet-end. Non-limiting examples of paper pulp where the mill-dried ATH particles can be used include chemical pulp such as KP; mechanical pulps such as SGP, RGP, BCTMP and CTMP; recycled paper pulp such as deinked pulp; non-wood pulp such as kenaf, bamboo, straw and hemp; organic synthetic fibers such as polyamide fiber, polyester fiber and polynosic fiber; inorganic fibers such as glass fiber, ceramic fiber and carbon fiber; and chlorine-free pulp such as ECF pulp and TCF pulp.

The mill-dried ATH particles are compatible with other additives commonly used in the production of paper. For example, pigments such as mineral pigments, for example kaolin, calcined kaolin, calcium carbonate, calcium sulfate, barium sulfate, titanium dioxide, talc, zinc oxide, alumina, magnesium carbonate, magnesium oxide, silica, white carbon, bentonite, zeolite, cerilite and smectite, and organic pigments such as polystyrene resins, urea resins, melamine resins, acrylic resins and vinylidene chloride resins, hollow and through-hole type resins thereof; various anionic, non-ionic, cationic or amphoteric retention aids; drainage-enhancing agents; paper strength-enhancing agents; sizing agents; dyes; fluorescent brightening agents; pH-adjusting agents; anti-foaming agents; pitch controlling agents; and slime controlling agents may be used as appropriate depending on the use of the paper.

The additives selected and the amount of the additive(s) used in the present invention is readily achievable by one having ordinary skill in the art and knowledge of the end use of the paper or paper product, etc.

Also, the paper production method where the mill-dried ATH particles find use is not limited, and any papermaking method can be used. Non-limiting examples of paper production methods where the mill-dried ATH particles can be used include acid papermaking methods; neutral papermaking methods; and alkaline papermaking methods; also, paper machines such as the Fourdrinier paper machine, the twin wire paper machine, the cylinder paper machine and the Yankee paper machine can be used as appropriate.

The above description is directed to several embodiments of the present invention. Those skilled in the art will recognize that other means, which are equally effective, could be devised for carrying out the spirit of this invention. It should also be noted that embodiments of the present invention contemplate that all ranges discussed herein include ranges from any lower amount to any higher amount within the discussed range. For example, when discussing the oil absorption of the dry-milled ATH, it is contemplated that ranges from about 30% to about 32%, about 19% to about 25%, about 21% to about 27%, etc. are within the scope of the present invention.

### Use of Mill-Dried ATH in Coating Formulations

The coating formulations of the present invention generally contain a binder or adhesive and at least the mill-dried ATH particles, typically as a component of a coating pigment (sometimes just simply referred to as a pigment), but may also contain other optional components commonly found in coating formulations used on paper and paper products. The amount of mill-dried ATH particles used in the coating formulations of the present invention is typically in the range of from about 5 wt. % to about 100 wt. %, or in the range of from about 10 wt. % to about 50 wt. %, or in the range of from about 15 wt. % to about 25 wt. %, all based on the total weight of the coating pigment used in the coating formulation, of the mill-dried ATH particles described above. It should be noted that all percentages given here are based on the coating pigment(s) used in the coating formulation. For example, a coating formulation may contain as the coating pigment a combination of CaCO₃, one or more clays, and ATH particles. In this case, when using the range of 10 wt. % to 50 wt. % ATH particles, the remainder of the 90 wt. % to 50 wt. % of the coating pigment is CaCO₃, one or more clays, or combinations thereof. This coating pigment can be used in combination with a binder (as described below), and optionally one or more additional components (as described below) along with the coating pigment made up of a combination of CaCO₃, one or more clays, and ATH particles. For example, the coating formulation can contain 87.2 wt. % pigment in combination with 12 wt. % binder, 0.5 wt % co-binder, 0.2 wt % dispersing agent, 0.1 wt % thickener, all based on the total weight of the coating or coating formulation, wherein the coating pigment contains 70 wt. % CaCO3, 20 wt. % Clay and 10 wt. % ATH, based on the total weight of the coating pigment.

Generally the amount of coating pigment used in the coating formulations of the present invention is in the range of from about 20 to about 92 wt. %, based on the total weight of the coating formulation, of the coating pigment. In some embodiments, the coating formulations of the present invention contain in the range of from about 80 to about 90 wt. %, in other embodiments, in the range of from about 85 to about 88 wt. %, both on the same basis, of the coating pigment.

The one or more binders selected for use in the coatings of the present invention can be any suitable binder known in the art, and the selection of the binder is readily achievable by one having ordinary skill in the art and knowledge of the end use of the paper or paper product, etc. Non-limiting examples of suitable binders include full saponificated polyvinyl alcohols; partial saponificated polyvinyl alcohols; carboxyl denatured polyvinyl alcohols; amide denatured polyvinyl alcohols; sulfonic acid denatured polyvinyl alcohols; butylal denatured polyvinyl alcohols; other denatured polyvinyl alcohols; hydroxyethyl cellulose; methyl cellulose; carboxy methyl cellulose; starches; gelatine; casein; sodium alginates; polyvinylpyrrolidones; polyacrylicamides; copolymers of acrylicamide/acrylic esters; alkaline salts of styrene/maleic acid anhydrides; water soluble resins such as alkaline salt of ethylene/maleic acid anhydrides; copolymers of styrene/butadiene; copolymers of acrylonitrile/butadienes; copolymers of acrylic methyl/butadiene; ternary copolymers of acrylonitrile/butadiene/styrenes; cellulosic derivatives such as ethylcellulose, acetylcellulose; water insoluble resins such as polyvinyl chloride, polyvinyl acetate, copolymers of vinyl acetate/acrylate, poly acrylate, copolymers of styrene/acrylate, polyurethane resins, polyvinylbutyral polystyrol and copolymers thereof, polyamide resins, silicone resins, petroleum resins, terpene resins, ketone resins, cumarone resins, and the like. It should be noted that these polymer compounds can be used by dissolving them in a solvent, or a blend of solvents, such as water, alcohol, ester or ketone, ester or hydrocarbon, and these polymers can be used in an emulsified state, paste state, dispersed in water or other medium and can be used according to the end use. It should be noted that if the desired end use of the paper product coated with a coating according to the present invention is a water-releasable or water soluble product; the binder can be suitably selected from starches, hydroxyethyl cellulose, methyl cellulose, carboxy methyl cellulose, gelatin, casein, sodium alginate, polyvinyl alcohol, denatured polyvinyl alcohol or polyvinylpyrrolidone, proteins such as casein, soy bean proteins and synthetic proteins as a main component of a binder. It should be noted that if more than one binder is used, one binder may be referred to as a co-binder.

Optionally, the coating formulations of the present invention can include one or more other additives commonly used in coatings and coating formulations. Non-limiting examples of suitable additives include additional fillers, dyes, dispersing agents, de-foaming agents, lubricants, UV stabilizers, sizing agents, sensitizers, fluorescence dyes, preservatives, colored pigments, thickening agents, water retention agents, antioxidants, anti-aging agents, conduction-inducing agents, anti-foaming agents, ultraviolet absorbing agents, pH adjusting agents, release agents, water resistant additives and water repellents, and the like. The amount of these optional additives is conventional and the selection of the optional additives used, their amounts, etc. is readily achievable by one having ordinary skill in the art and knowledge of the end use of the paper or paper product, etc.

The coating formulations of the present invention may also contain one or more additional pigments or fillers. Non-limiting examples of pigments or fillers include calcium carbonate, calcined kaolin, engineered kaolin, delaminated kaolin, talc, calcium sulfate, barium sulfate, aluminum hydroxides other than those meeting the properties of the mill-dried ATH particles described above, satin white, titanium dioxide, zinc oxide, alumina, magnesium carbonate, magnesium oxide, silica, magnesium aluminosilicate, bentonite calcium silicate, zeolite, cerilite, smectite; and organic pigments such as solid, hollow or through-hole type resins of polystyrene resins, styrene-acrylic copolymer resins, urea resins, melamine resins, acrylic resins, vinylidene chloride resins, and benzoguanamine resins.

If the coating formulation is to be used in a thermally sensitive recording layer, sometimes to be coated on an undercoat layer, public known leuco dyes can be used alone or can be used together with, especially, leuco compounds of triphenylmethane dyes, fluorane dyes, phenothiazine dyes, auramine dyes, spiropyrane dyes or indolinophthalide dyes. In the thermally sensitive recording layer, a supplemental additive component, for example, sensitizers, fillers, stabilizers such as metallic salt of p-nitrobenzoic acid (Ca, Zn) or metallic salts of phthalic acidmonobenzyl ester (Ca, Zn), parting agents such as metallic salt of fatty acid, slipping agent such as waxes, inhibitors for pressure coloring, ultra violet ray absorbing agents, water resisting agents such as glyoxal, dispersing agent or defoaming agent can be used when needed.

The coating formulations of the present invention can be produced by combining, in any suitable manner and any suitable order, the mill-dried ATH particles, binder, and optional components, if used. The mill-dried ATH particles can be provided in a mill-dried ATH product slurry, as described above.

The coating formulations of the present invention can be applied in one or more layers to one or more parts of a paper sheet and one or both sides of the paper. For example, the coating formulations can be applied to a top sheet in one or more layer or applied to a bottom or base sheet in one or more layers. In some embodiments, the coating formulations of the present invention can be applied in one or more layers to both the top sheet and the bottom or base sheet. The coating formulations can also be applied to a single layer paper sheet, i.e. a one-ply sheet.

The method by which the coating formulations of the present invention are applied to the paper sheet is not critical to the present invention, and one having ordinary skill in the art and knowledge of the end use of the paper or paper product, the coating, etc. can readily select the best coating method/machine to be used. Non-limiting examples of suitable coating methods/machines include air knife coater, bar coater, roll coater, blade coater curtain coater, champflex coater or gravure. In some embodiments, the coated paper can be subjected to a finishing process such as heating and/or drying the coated paper and/or supercalender, gloss calender, soft calender or the like.

The above description is directed to several embodiments of the present invention. Those skilled in the art will recognize that other means, which are equally effective, could be devised for carrying out the spirit of this invention.

### EXAMPLE

The following example is illustrative of the principles of this invention. It is understood that this invention is not limited to any one specific embodiment exemplified herein, whether in the example or the remainder of this patent application. Several slurries were made in a “disc dissolver” marketed under the name Dispermat® F1, commercially available from VMA Getzmann, using commercially available ATH particles and mill-dried ATH particles as described above. These slurries were made by combining 3.43 g of a polyacrylic acid dispersing agent, commercially available under the name Coatex PA 1249, which had an active concentration of 49 wt. %. The dispersing agent was added to about 294 g of water and mixed for one minute. After the water and dispersing agent were mixed, ATH particles were added, under agitation, to the dispersing agent/water mixture. The dispersing agent/water/ATH mixture was stirred at 3000 rpm for ten minutes, and then 400 ppm Proxel® GXL biocide, commercially available from Arch, was added and the dispersing agent/water/ATH mixture, which was stirred under the same conditions for ten minutes. The four slurries made, their solids content, and their viscosity are described in Table 1, below.

TABLE 1

| | | Viscosity |
|---|---|---|
| | Solids Content of Resulting | (ηᵣₑₚ, 1007 s⁻¹) |
| | Slurry (wt. %, based on the | ((millipascals) |
| ATH used in Slurry | total weight of the slurry) | (seconds)) |
| *MARTIGLOSS | 64.4 | 36 |
| MARTIFIN-008U | 65.3 | 97 |
| **Mill Dried ATH having a | 69.3 | 37 |
| BET of about 7 m²/g | | |
| **Mill Dried ATH having a | 71.6 | 41 |
| BET of about 7 m²/g | | |

*MARTIGLOSS is an ATH slurry currently available commercially from Martinswerk, GMBH.
**According to the present invention.

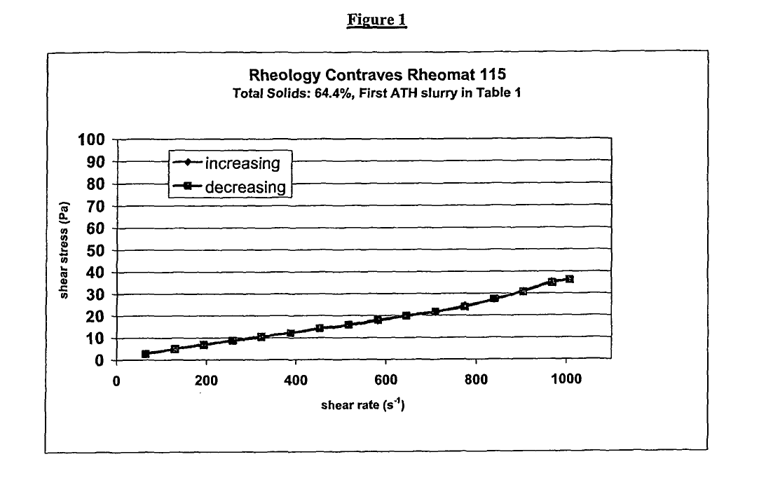

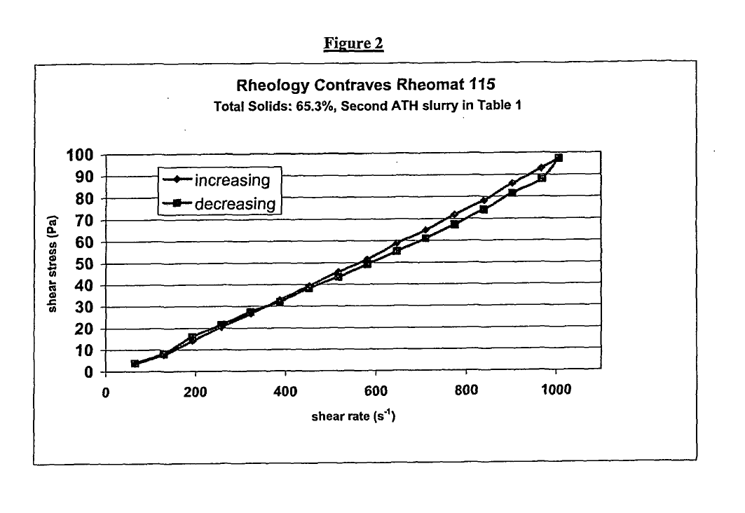

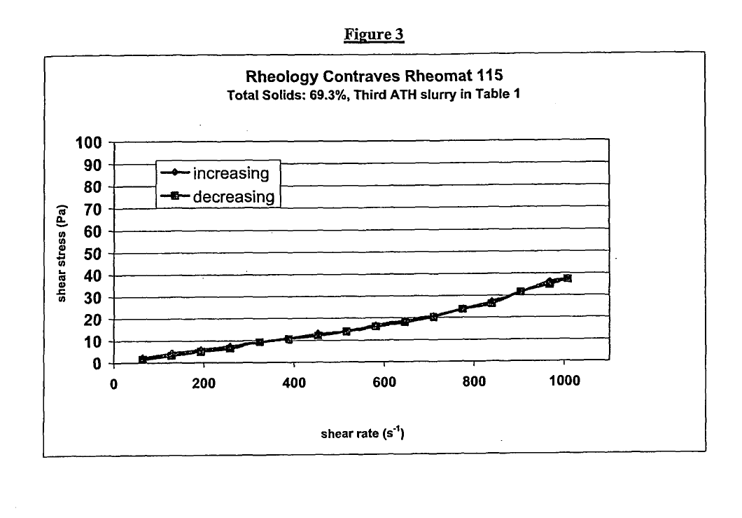

As can be seen in Table 1, by using mill-dried ATH particles, slurries having a higher solids content, when compared to slurries conventionally available or using ATH particles commercially available, can be produced. At the same time, these slurries have a viscosity that is similar to slurries with a lower solids concentration of conventional ATH particles. For example, the third slurry (counting from the top of the list) in the list above, one according to the present invention, to the second slurry, the slurry according to the present invention has a solids content considerably higher than the second slurry but has a viscosity much lower. FIGS. 1, 2, and 3, illustrate the differing rheological behaviors of the slurries of the first three entries in Table 1. FIG. 1 illustrates the behavior of the slurry using MARTIGLOSS. FIG. 2 illustrates the behavior of the slurry using MARTIFIN-008U. FIG. 3 illustrates the behavior of the slurry of entry 3 using a mill-dried ATH product of the present invention. The milled dried ATH of the present invention is beneficial in that it can be used to make a slurry with a solid content >65% and a low viscosity at a shear rate >1000/s, without an additional milling step of the slurry and using powder instead of filter cake.

The following is a non-limiting list of embodiments of this invention:
1) A slurry comprising mill-dried ATH particles and at least one wood pulp suitable for use in making paper and/or paper products.
2) The slurry according to embodiment 1 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm.
3) The slurry according to embodiment 1 wherein said wood pulp is selected from chemical pulps, mechanical pulps, recycled paper pulp, non-wood pulp, organic synthetic fibers, inorganic fibers, and chlorine-free pulp.
4) The slurry according to embodiment 1 wherein said slurry contains one or more additives commonly used in the production of paper.
5) The slurry according to embodiment 4 wherein said one or more additives are selected from pigments retention aids; drainage-enhancing agents; paper strength-enhancing agents; sizing agents; dyes; fluorescent brightening agents; pH-adjusting agents; anti-foaming agents; pitch controlling agents; and slime controlling agents.
6) The slurry according to embodiment 1 wherein said mill-dried ATH particles are characterized by:
   a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, and a Vₘₐₓ in the range of from about 390 to about 480 mm³/g;
      or
   b) a BET in the range of from about 6 to about 9 m²/g, a d₅₀ in the range of from about 1.0 to about 2.0 μm, an oil absorption in the range of from about 25 to about 40%, an r₅₀ in the range of from about 0.185 to about 0.325 μm, and a Vₘₐₓ in the range of from about 400 to about 600 mm³/g;
      or
   c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, and a Vₘₐₓ in the range of from about 300 to about 700 mm³/g.
7) The slurry according to embodiment 1 wherein said slurry contains in the range of from about 2 wt. % to about 60 wt. %, based on the total weight of the dry paper, of said mill-dried ATH particles.
8) The use of mill-dried ATH particles as a filler in the production of paper and/or paper products.
9) The use according to embodiment 8 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm.
10) The use according to embodiment 8 wherein said mill-dried ATH particles are used in combination with at least one or more additives selected from pigments retention aids; drainage-enhancing agents; paper strength-enhancing agents; sizing agents; dyes; fluorescent brightening agents; pH-adjusting agents; anti-foaming agents; pitch controlling agents; and slime controlling agents.
11) The use according to embodiment 8 wherein said mill-dried ATH particles are characterized by:
   a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, and a Vₘₐₓ in the range of from about 390 to about 480 mm³/g;
      or
   b) a BET in the range of from about 6 to about 9 m²/g, a d₅₀ in the range of from about 1.0 to about 2.0 μm, an oil absorption in the range of from about 25 to about 40%, an r₅₀ in the range of from about 0.185 to about 0.325 μm, and a Vₘₐₓ in the range of from about 400 to about 600 mm³/g;
      or
   c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, and a Vₘₐₓ in the range of from about 300 to about 700 mm³/g.
12) The use according to embodiment 8 wherein said mill-dried ATH particles are used as opacity and/or brightness and/or printability and/or flame retardant improvers.
13) The use according to claim 8 wherein said mill-dried ATH particles are used as a wet-end additive.
14) The use according to embodiment 8 wherein in the range of from about 2 wt. % to about 60 wt. %, based on dry paper weight, is used
15) The use according to embodiment 12 wherein said mill-dried ATH particles are used as an opacity and/or brightness and/or printability improver.
16) The use according to embodiment 15 wherein said mill-dried ATH particles are used in an amount in the range of from about 2 wt. % to about 30 wt. %, based on dry paper weight.
17) The use according to embodiment 12 wherein said mill-dried ATH particles are used as a flame retardant improver.
18) The use according to embodiment 15 wherein said mill-dried ATH particles are used in an amount in the range of from about 5 wt. % to about 60 wt. %, based on dry paper weight.
19) Paper or paper products comprising mill-dried ATH particles.
20) The paper or paper products according to embodiment 19 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm.
21) The paper or paper products according to embodiment 19 wherein said mill-dried ATH particles are characterized by:
   a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, and a Vₘₐₓ in the range of from about 390 to about 480 mm³/g;
      or
   b) a BET in the range of from about 6 to about 9 m²/g, a d₅₀ in the range of from about 1.0 to about 2.0 μm, an oil absorption in the range of from about 25 to about 40%, an r₅₀ in the range of from about 0.185 to about 0.325 μm, and a Vₘₐₓ in the range of from about 400 to about 600 mm³/g;
      or
   c) a BET in the range of from about 9 to about 15 m²/g and a d₅₀ in the range of from about 0.9 to about 1.8 μm, an oil absorption in the range of from about 25 to about 50%, an rₛₒ in the range of from about 0.09 to about 0.21 μm, and a Vₘₐₓ in the range of from about 300 to about 700 mm³/g.

The following is a non-limiting list of additional embodiments of this invention:
22) A slurry comprising up to about 85 wt. % mill-dried ATH particles, and (a) one or more dispersing agents, (b) water, or (c) combinations of (a) and (b), wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm.
23) The slurry according to embodiment 22 wherein said mill-dried ATH particles are characterized by:
   a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, and a Vₘₐₓ in the range of from about 390 to about 480 mm³/g;

### Or

b) a BET in the range of from about 6 to about 9 m²/g, a d₅₀ in the range of from about 1.0 to about 2.0 μm, an oil absorption in the range of from about 25 to about 40%, an r₅₀ in the range of from about 0.185 to about 0.325 μm, and a Vₘₐₓ in the range of from about 400 to about 600 mm³/g;

### Or

c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, and a Vₘₐₓ in the range of from about 300 to about 700 mm³/g.
24) The slurry according to embodiment 23 wherein said slurry contains: i) in the range of from about 65 wt. % to about 75 wt. % mill-dried ATH particles; ii) in the range of from about 68 wt. % to about 75 wt. % mill-dried ATH particles; iii) in some embodiments in the range of from about 70 wt. % to about 74 wt. % mill-dried ATH particles; iv) in the range of from about 50 wt. % to about 85%; v) in the range of from about 60 wt. % to about 80 wt. %; vi) in the range of from about 65 wt. % to about 75 wt. %, wherein all wt. % are based on the total weight of the slurry.
25) The slurry according to embodiment 24 wherein said slurry has a viscosity in the range of from about 10 mPa*s to about 60 mPa*s, or in the range from 25 mPa*s to 45 mPa*s, wherein said viscosity is determined by representative dynamical viscosity at 25° C. at a shear rate of 1007/second.
26) The use of a slurry according to embodiments 22 or 25 in producing a coating formulation.
27) A coating formulation comprising:
   a) a coating pigment;
   b) one or more binders or adhesives; and optionally
   c) one or more additive selected from additional fillers, dyes, dispersing agents, de-foaming agents, lubricants, UV stabilizers, sizing agents, sensitizers, fluorescence dyes, preservatives, colored pigments, thickening agents, water retention agents, antioxidants, anti-aging agents, conduction-inducing agents, anti-foaming agents, ultraviolet absorbing agents, pH adjusting agents, release agents, water resistant additives and water repellents, and the like,
   wherein, said coating pigment contains at least mill-dried ATH particles having an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm
28) The coating formulation according to embodiment 27 wherein said coating pigment contains a) in the range of from about 5 wt. % to about 100 wt. % mill-dried ATH particles; b) in the range of from about 10 wt. % to about 50 wt. % mill-dried ATH particles; c) in the range of from about 15 wt. % to about 25 wt. % mill-dried ATH particles, all based on the total weight of the coating pigment.
29) The coating formulation according to embodiment 28 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm.
30) The coating formulation according to embodiment 27 wherein said coating pigment further contains one or more additional pigments or fillers selected from calcium carbonate, calcined kaolin, engineered kaolin, delaminated kaolin, talc, calcium sulfate, barium sulfate, aluminum hydroxides other than the mill-dried ATH particles, satin white, titanium dioxide, zinc oxide, alumina, magnesium carbonate, magnesium oxide, silica, magnesium aluminosilicate, bentonite calcium silicate, zeolite, cerilite, smectite; and organic pigments such as solid, hollow or through-hole type resins of polystyrene resins, styrene-acrylic copolymer resins, urea resins, melamine resins, acrylic resins, vinylidene chloride resins, and benzoguanamine resins.
31) The coating formulation according to any of embodiments 27 or 31 wherein said coating pigment further contains leuco dyes used alone or together with, leuco compounds of triphenylmethane dyes, fluorane dyes, phenothiazine dyes, auramine dyes, spiropyrane dyes or indolinophthalide dyes.
32) The coating formulation according to embodiment 31 wherein said coating pigment further contains one or more sensitizers, fillers, stabilizers selected from metallic salts of p-nitrobenzoic acid (Ca, Zn) or metallic salts of phthalic acidmonobenzyl ester (Ca, Zn), parting agents, slipping agent, inhibitors for pressure coloring, ultra violet ray absorbing agents, water resisting agents, dispersing agents or defoaming agents.
33) The coating formulation according to embodiment 27 wherein said one or more binders is selected from full saponificated polyvinyl alcohols; partial saponificated polyvinyl alcohols; carboxyl denatured polyvinyl alcohols; amide denatured polyvinyl alcohols; sulfonic acid denatured polyvinyl alcohols; butylal denatured polyvinyl alcohols; other denatured polyvinyl alcohols; hydroxyethyl cellulose; methyl cellulose; carboxy methyl cellulose; starches; gelatine; casein; sodium alginates; polyvinylpyrrolidones; polyacrylicamides; copolymers of acrylicamide/acrylic esters; alkaline salts of styrene/maleic acid anhydrides; water soluble resins such as alkaline salt of ethylene/maleic acid anhydrides; copolymers of styrene/butadiene; copolymers of acrylonitrile/butadienes; copolymers of acrylic methyl/butadiene; ternary copolymers of acrylonitrile/butadiene/styrenes; cellulosic derivatives such as ethylcellulose, acetylcellulose; water insoluble resins such as polyvinyl chloride, polyvinyl acetate, copolymers of vinyl acetate/acrylate, poly acrylate, copolymers of styrene/acrylate, polyurethane resins, polyvinylbutyral polystyrol and copolymers thereof, polyamide resins, silicone resins, petroleum resins, terpene resins, ketone resins, cumarone resins; starches; hydroxyethyl cellulose; methyl cellulose; carboxy methyl cellulose; gelatin; casein; sodium alginate; polyvinyl alcohol; denatured polyvinyl alcohol or polyvinylpyrrolidone; proteins selected from casein, soy bean proteins and synthetic proteins.
34) The coating formulation according to embodiment 27 wherein said coating formulation is applied in one or more layers to one or more parts of a paper sheet and one or both sides of the paper sheet.
35) The coating formulation according to embodiment 34 wherein said coating formulation is applied by a coating method/machine selected from air knife coaters, bar coaters, roll coaters, blade coaters, curtain coaters, champflex coaters, or gravure coaters.
36) A coated paper having at least two sides and two edges having a coating on at least one of said two sides, said coating derivable from a coating pigment; one or more binders or adhesives; and optionally one or more additive selected from additional fillers, dyes, dispersing agents, de-foaming agents, lubricants, UV stabilizers, sizing agents, sensitizers, fluorescence dyes, preservatives, colored pigments, thickening agents, water retention agents, antioxidants, anti-aging agents, conduction-inducing agents, anti-foaming agents, ultraviolet absorbing agents, pH adjusting agents, release agents, water resistant additives and water repellents, and the like, wherein, said coating pigment contains at least mill-dried ATH particles having an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm
37) The coated paper according to embodiment 36 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅”) in the range of from about 0.09 to about 0.33 μm.
38) The coated paper according to embodiment 36 wherein said coating pigment further contains one or more additional pigments or fillers selected from calcium carbonate, calcined kaolin, engineered kaolin, delaminated kaolin, talc, calcium sulfate, barium sulfate, aluminum hydroxides other than the mill-dried ATH particles, satin white, titanium dioxide, zinc oxide, alumina, magnesium carbonate, magnesium oxide, silica, magnesium aluminosilicate, bentonite calcium silicate, zeolite, cerilite, smectite; and organic pigments such as solid, hollow or through-hole type resins of polystyrene resins, styrene-acrylic copolymer resins, urea resins, melamine resins, acrylic resins, vinylidene chloride resins, and benzoguanamine resins.
39) The coated paper formulation according to any of embodiments 36 or 38 wherein said coating pigment further contains leuco dyes used alone or together with, leuco compounds of triphenylmethane dyes, fluorane dyes, phenothiazine dyes, auramine dyes, spiropyrane dyes or indolinophthalide dyes.
40) The coated paper according to embodiment 39 wherein said coating pigment further contains one or more sensitizers, fillers, stabilizers selected from metallic salts of p-nitrobenzoic acid (Ca, Zn) or metallic salts of phthalic acidmonobenzyl ester (Ca, Zn), parting agents, slipping agent, inhibitors for pressure coloring, ultra violet ray absorbing agents, water resisting agents, dispersing agents or defoaming agents.
41) The coated paper according to embodiment 36 wherein said one or more binders is selected from full saponificated polyvinyl alcohols; partial saponificated polyvinyl alcohols; carboxyl denatured polyvinyl alcohols; amide denatured polyvinyl alcohols; sulfonic acid denatured polyvinyl alcohols; butylal denatured polyvinyl alcohols; other denatured polyvinyl alcohols; hydroxyethyl cellulose; methyl cellulose; carboxy methyl cellulose; starches; gelatine; casein; sodium alginates; polyvinylpyrrolidones; polyacrylicamides; copolymers of acrylicamide/acrylic esters; alkaline salts of styrene/maleic acid anhydrides; water soluble resins such as alkaline salt of ethylene/maleic acid anhydrides; copolymers of styrene/butadiene; copolymers of acrylonitrile/butadienes; copolymers of acrylic methyl/butadiene; ternary copolymers of acrylonitrile/butadiene/styrenes; cellulosic derivatives such as ethylcellulose, acetylcellulose; water insoluble resins such as polyvinyl chloride, polyvinyl acetate, copolymers of vinyl acetate/acrylate, poly acrylate, copolymers of styrene/acrylate, polyurethane resins, polyvinylbutyral polystyrol and copolymers thereof, polyamide resins, silicone resins, petroleum resins, terpene resins, ketone resins, cumarone resins; starches; hydroxyethyl cellulose; methyl cellulose; carboxy methyl cellulose; gelatin; casein; sodium alginate; polyvinyl alcohol; denatured polyvinyl alcohol or polyvinylpyrrolidone; proteins selected from casein, soy bean proteins and synthetic proteins.
42) The coated paper according to embodiment 36 wherein said coating formulation is applied in one or more layers to one or more sides of said coated paper.
43) The coated paper according to embodiment 36 wherein said coated paper is subjected to a finishing process.
44) The coated paper according to embodiment 43 wherein said finishing process is selected from one or more of heating; drying; supercalendering; gloss calendaring; soft calendaring; or the like.
45) A paper product made from the coated paper of embodiment 36.

While the present invention has been described in terms of one or more preferred embodiments, it is to be understood that other modifications may be made without departing from the scope of the invention, which is set forth in the claims below.

What is claimed:

1) A slurry comprising mill-dried ATH particles and at least one wood pulp suitable for use in making paper and/or paper products.

2) The slurry according to claim 1 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm.

3) The slurry according to claim 1 wherein said wood pulp is selected from chemical pulps, mechanical pulps, recycled paper pulp, non-wood pulp, organic synthetic fibers, inorganic fibers, and chlorine-free pulp.

4) The slurry according to claim 1 wherein said slurry contains one or more additives commonly used in the production of paper.

5) The slurry according to claim 4 wherein said one or more additives are selected from pigments retention aids; drainage-enhancing agents; paper strength-enhancing agents; sizing agents; dyes; fluorescent brightening agents; pH-adjusting agents; anti-foaming agents; pitch controlling agents; and slime controlling agents.

6) The slurry according to claim 1 wherein said mill-dried ATH particles are characterized by:
a) a BET in the range of from about 3 to about 6 m²/g, a d₅₀ in the range of from about 1.5 to about 2.5 μm, an oil absorption in the range of from about 23 to about 30%, an r₅₀, in the range of from about 0.2 to about 0.33 μm, and a Vₘₐₓ in the range of from about 390 to about 480 mm³/g;
or
b) a BET in the range of from about 6 to about 9 m²/g, a d₅₀ in the range of from about 1.0 to about 2.0 μm, an oil absorption in the range of from about 25 to about 40%, an r₅₀ in the range of from about 0.185 to about 0.325 μm, and a Vₘₐₓ in the range of from about 400 to about 600 mm³/g;
or
c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, and a Vₘₐₓ in the range of from about 300 to about 700 mm³/g.

7) The use of mill-dried ATH particles as a filler in the production of paper and/or paper products.

8) Paper or paper products comprising mill-dried ATH particles.

9) The paper or paper products according to claim 8 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d₅₀ in the range of from about 0.5 to 2.5 μm; a maximum specific pore volume at about 1000 bar (“Vₘₐₓ”) in the range of from about 300 to about 700 mm³/g; and/or an median pore radius (“r₅₀”) in the range of from about 0.09 to about 0.33 μm.

10) A slurry comprising up to about 85 wt. % mill-dried ATH particles, and (a) one or more dispersing agents, (b) water, or (c) combinations of (a) and (b), wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d50 in the range of from about 0.5 to 2.5 μm; a maximum specific pore volume at about 1000 bar (“Vmax”) in the range of from about 300 to about 700 mm³/g; and/or an median pore radius (“r50”) in the range of from about 0.09 to about 0.33 μm.

11) The slurry according to claim 10 wherein said mill-dried ATH particles are characterized by:
a) a BET in the range of from about 3 to about 6 m²/g, a d50 in the range of from about 1.5 to about 2.5 μm, an oil absorption in the range of from about 23 to about 30%, an r50 in the range of from about 0.2 to about 0.33 μm, and a Vmax in the range of from about 390 to about 480 mm³/g;
or
b) a BET in the range of from about 6 to about 9 m²/g, a d50 in the range of from about 1.0 to about 2.0 μm, an oil absorption in the range of from about 25 to about 40%, an r50 in the range of from about 0.185 to about 0.325 μm, and a Vmax in the range of from about 400 to about 600 mm³/g;
or
c) a BET in the range of from about 9 to about 15 m²/g and a d50 in the range of from about 0.9 to about 1.8 μm, an oil absorption in the range of from about 25 to about 50%, an r50 in the range of from about 0.09 to about 0.21 μm, and a Vmax in the range of from about 300 to about 700 mm³/g.

12) The slurry according to claim 11 wherein said slurry contains: i) in the range of from about 65 wt. % to about 75 wt. % mill-dried ATH particles; ii) in the range of from about 68 wt. % to about 75 wt. % mill-dried ATH particles; in some embodiments in the range of from about 70 wt. % to about 74 wt. % mill-dried ATH particles; iv) in the range of from about 50 wt. % to about 85%; v) in the range of from about 60 wt. % to about 80 wt. %; vi) in the range of from about 65 wt. % to about 75 wt. %, wherein all wt. % are based on the total weight of the slurry.

13) The slurry according to claim 12 wherein said slurry has a viscosity in the range of from about 10 mPa*s to about 60 mPa*s, wherein said viscosity is determined by representative dynamical viscosity at 25° C. at a shear rate of 1007/second.

14) The use of a slurry according to claim 10 or 13 in producing a coating formulation.

15) A coating formulation comprising:
a) a coating pigment;
b) one or more binders or adhesives; and optionally
c) one or more additive selected from additional fillers, dyes, dispersing agents, de-foaming agents, lubricants, UV stabilizers, sizing agents, sensitizers, fluorescence dyes, preservatives, colored pigments, thickening agents, water retention agents, antioxidants, anti-aging agents, conduction-inducing agents, anti-foaming agents, ultraviolet absorbing agents, pH adjusting agents, release agents, water resistant additives and water repellents, and the like,
wherein, said coating pigment contains at least mill-dried ATH particles having an oil absorption as determined by ISO 787-5:1980 of in the range of from about 1 to about 35%; a BET specific surface area, as determined by DIN-66132, in the range of from about 1 to 15 m²/g; a d50 in the range of from about 0.5 to 2.5 μm; a maximum specific pore volume at about 1000 bar (“Vmax”) in the range of from about 300 to about 700 mm³/g; and/or an median pore radius (“r50”) in the range of from about 0.09 to about 0.33 μm

16) The coating formulation according to claim 15 wherein said coating pigment contains a) in the range of from about 5 wt. % to about 100 wt. % mill-dried ATH particles; b) in the range of from about 10 wt. % to about 50 wt. % mill-dried ATH particles; c) in the range of from about 15 wt. % to about 25 wt. % mill-dried ATH particles, all based on the total weight of the coating pigment.

17) A coated paper having at least two sides and two edges having a coating on at least one of said two sides, said coating derivable from a coating pigment; one or more binders or adhesives; and optionally one or more additive selected from additional fillers, dyes, dispersing agents, de-foaming agents, lubricants, UV stabilizers, sizing agents, sensitizers, fluorescence dyes, preservatives, colored pigments, thickening agents, water retention agents, antioxidants, anti-aging agents, conduction-inducing agents, anti-foaming agents, ultraviolet absorbing agents, pH adjusting agents, release agents, water resistant additives and water repellents, and the like, wherein, said coating pigment contains at least mill-dried ATH particles having an oil absorption as determined by ISO 787-5:1980 of in the range of from about 1 to about 35%; a BET specific surface area, as determined by DIN-66132, in the range of from about 1 to 15 m²/g; a d50 in the range of from about 0.5 to 2.5 μm; a maximum specific pore volume at about 1000 bar (“Vmax”) in the range of from about 300 to about 700 mm³/g; and/or an median pore radius (“r50”) in the range of from about 0.09 to about 0.33 μm

18) The coated paper according to claim 17 wherein said mill-dried ATH particles have an oil absorption as determined by ISO 787-5:1980 of in the range of from about 1 to about 35%; a BET specific surface area, as determined by DIN-66132, in the range of from about 1 to 15 m²/g; a d50 in the range of from about 0.5 to 2.5 μm; a maximum specific pore volume at about 1000 bar (“Vmax”) in the range of from about 300 to about 700 mm³/g; and/or an median pore radius (“r50”) in the range of from about 0.09 to about 0.33 μm.

19) The coated paper according to claim 17 wherein said coating pigment further contains one or more additional pigments or fillers selected from calcium carbonate, calcined kaolin, engineered kaolin, delaminated kaolin, talc, calcium sulfate, barium sulfate, aluminum hydroxides other than the mill-dried ATH particles, satin white, titanium dioxide, zinc oxide, alumina, magnesium carbonate, magnesium oxide, silica, magnesium aluminosilicate, bentonite calcium silicate, zeolite, cerilite, smectite; and organic pigments such as solid, hollow or through-hole type resins of polystyrene resins, styrene-acrylic copolymer resins, urea resins, melamine resins, acrylic resins, vinylidene chloride resins, and benzoguanamine resins.

20) A paper product made from the coated paper of claim 17.
